(19) United States
(12) Patent Application Publication
(10) Pub. No.: US 2022/0117854 A1
(43) Pub. Date: Apr. 21, 2022

(54) Casing

(71) Applicant: Mushie & Co., Houston, TX (US)

(72) Inventor: Mushka Stambler, Houston, TX (US)

(21) Appl. No.: 17/075,314

(22) Filed: Oct. 20, 2020

(51) Int. Cl. A61J 17/00

(52) U.S. Cl. CPC A61J 17/113; A61J 17/111

(57) ABSTRACT

A casing for pacifiers is disclosed. The casing comprises a body portion having an inner space large enough to receive and contain at least one pacifier, wherein the body portion is provided with a slot large enough to let a pacifier enter the inner space through the slot. The body portion is configured to be arranged in a resting configuration, in which the opening in the slot is so small that the pacifier cannot pass through the slot, and an open configuration, in which the opening in the slot is large enough to let the pacifier pass through the slot. The body portion is configured to reshape to its resting configuration when no external contact forces are applied to the body portion.

### FIELD OF INVENTION

The present invention relates to a receptacle for storage and transport of pacifiers.

### BACKGROUND

Parents want to protect their children and provide the best options for them. Baby's pacifiers should be stored well and kept clean. Moreover, pacifiers should be protected during storage and transportation.

In order to keep pacifiers safe and clean during storage and transportation various types of receptacles have been developed. The prior art receptacles often comprise two parts that can be mechanically connected to each other.

A typical receptacle for pacifiers is, however, difficult to open and to keep closed because it comprises a mechanical locking arrangement. Moreover, typical receptacles can be difficult to clean.

Thus, there is a need for a receptacle that reduces or even eliminates the above-mentioned disadvantages of the prior art.

### SUMMARY

It is an object of the invention to provide a receptacle for storage and transportation of pacifiers, wherein the receptacle is easy to use and suitable for being cleaned in a washing machine.

A casing according to the invention is a casing for pacifiers, wherein the casing comprises a body portion having an inner space large enough to receive and contain at least one pacifier, wherein the body portion provided with a slot large enough to let a pacifier enter the inner space through the slot, wherein the body portion is configured to be arranged in:

a) a resting configuration, in which the opening in the slot is so small that the pacifier cannot pass through the slot and
b) an open configuration, in which the opening in the slot is large enough to let the pacifier pass through the slot,
wherein the body portion is configured to reshape to its resting configuration when no external contact forces are applied to the body portion.

Hereby, it is possible to provide a casing that is easy to use and suitable for being cleaned in a washing machine. Moreover, the casing effectively protects one or more pacifiers against dirt and contamination.

Since the casing comprises a simple opening mechanism without any joints or covers, the casing is very simple to use.

The casing comprises an inner space large enough to receive and contain at least one pacifier. It is possible to provide the casing in several variants.

In one embodiment, the casing is designed to receive a single pacifier.

In one embodiment, the casing is designed to receive two pacifiers.

In one embodiment, the casing is designed to receive three pacifiers.

In one embodiment, the casing is designed to receive four pacifiers.

In one embodiment, the casing is designed to receive five pacifiers.

The casing comprises a body portion provided with a slot large enough to let a pacifier enter the inner space through the slot. The slot also functions as a vent so dry air can enter the space and dry the pacifier.

The body portion is configured to be arranged in a first resting configuration, in which the opening in the slot is so small that the pacifier cannot pass through the slot.

In one embodiment, the slot is entirely closed in the resting configuration.

In one embodiment, the slot has a width of 1-2 mm in the resting configuration.

In one embodiment, the slot has a width of 2-3 mm in the resting configuration.

In one embodiment, the slot has a width of 3-4 mm in the resting configuration.

In one embodiment, the slot has a width of 4-5 mm in the resting configuration.

In one embodiment, the slot has a width of 5-6 mm in the resting configuration.

In one embodiment, the slot has a width of 6-7 mm in the resting configuration.

In one embodiment, the slot has a width of more than 7 mm in the resting configuration.

The body portion is configured to be arranged in a second open configuration, in which the opening in the slot is large enough to let the pacifier pass through the slot. In this open configuration the width of the slot must be large enough to allow a pacifier to enter into the inner space of the body portion.

It is important that the body portion is configured to reshape to its resting configuration when no external contact forces are applied to the body portion. Hereby, the casing automatically closes, thus being brought into the resting configuration. This can be accomplished by producing the body portion in a resilient material.

In one embodiment, the casing is provided with an attachment member fixed to the body portion, wherein the attachment member comprises an elongated open part large enough to let the body portion pass through the open part.

Hereby, it is possible to fix the casing to a structure such as a rod or a coat hook.

In one embodiment, the attachment member is made of the same material as the body portion of the casing.

In one embodiment, the body portion is spherical in the resting configuration.

In one embodiment, the body portion is made of a resilient and compressible material such as rubber or silicone.

In one embodiment, the body portion of the casing is made of a rubber material.

In one embodiment, the body portion of the casing is made of natural rubber.

In one embodiment, the body portion of the casing is made of silicone.

In an embodiment, the casing is made of a material that is suitable for being washed in a washing machine at a temperature high enough to disinfect and sterilize all of the surfaces of the casing.

In one embodiment, the slot extends along at least 60 degrees of the surface of the body portion. It is important that the slot extends along a large enough portion of the surface of the body portion in order to allow a pacifier to be inserted into the body portion and to be removed from the body portion.

In one embodiment, the slot extends along 50-55 degrees of the surface of the body portion.

In one embodiment, the slot extends along 55-60 degrees of the surface of the body portion.

In one embodiment, the slot extends along 60-65 degrees of the surface of the body portion.

In one embodiment, the slot extends along 65-70 degrees of the surface of the body portion.

In one embodiment, the slot extends along 70-75 degrees of the surface of the body portion.

In one embodiment, the slot extends along 75-80 degrees of the surface of the body portion.

In one embodiment, the slot extends along 80-85 degrees of the surface of the body portion.

In one embodiment, the slot extends along 85-90 degrees of the surface of the body portion.

In one embodiment, a round-off portion is provided in each end of the slot. Hereby, cracking of the portion adjacent to the slot can be prevented.

In one embodiment, the round-off portions are shaped as a sector of a circle.

In one embodiment, the round-off portions are shaped as a sector corresponding to 50-75% of a circle.

In one embodiment, the round-off portions are shaped as a sector corresponding to 75-80% of a circle.

In one embodiment, the round-off portions are shaped as a sector corresponding to 80-90% of a circle.

In one embodiment, the round-off portions are shaped as a sector corresponding to 90-95% of a circle.

In one embodiment, the thickness of the slot is less than 10% of the thickness of the body portion.

In one embodiment, the length of the open part of the attachment member is more than half the length of the attachment member.

In one embodiment, the attachment member comprises a distal portion having a larger width than the width of the central portion of the attachment member.

In one embodiment, the thickness of the body portion is larger than the length of the slot.

In one embodiment, the thickness of the wall of the body portion is in the range 0.5-1 mm.

In one embodiment, the thickness of the wall of the body portion is in the range 1-2 mm.

In one embodiment, the thickness of the wall of the body portion is in the range 2-3 mm.

In one embodiment, the thickness of the wall of the body portion is in the range 3-4 mm.

In one embodiment, the thickness of the wall of the body portion is in the range 4-5 mm.

In one embodiment, the thickness of the wall of the body portion is in the range 5-6 mm.

In one embodiment, the thickness of the wall of the body portion is in the range 6-7 mm.

In one embodiment, the thickness of the wall of the body portion is in the range 7-8 mm.

In one embodiment, the inner space of the body portion is configured to contain at least three pacifiers of small size adapted to fit children of 0-6 months.

In one embodiment, the inner space of the body portion has a volume in the range 50-300 cm³.

In one embodiment, the inner space of the body portion has a volume in the range 30-40 cm³.

In one embodiment, the inner space of the body portion has a volume in the range 40-50 cm³.

In one embodiment, the inner space of the body portion has a volume in the range 50-75 cm³.

In one embodiment, the inner space of the body portion has a volume in the range 75-100 cm³.

In one embodiment, the inner space of the body portion has a volume in the range 100-125 cm³.

In one embodiment, the inner space of the body portion has a volume in the range 125-150 cm³.

In one embodiment, the inner space of the body portion has a volume in the range 150-200 cm³.

In one embodiment, the inner space of the body portion has a volume in the range 200-250 cm³.

In one embodiment, the inner space of the body portion has a volume in the range 250-300 cm³.

In one embodiment, the inner space of the body portion has a volume in the range 300-350 cm³.

In one embodiment, the casing comprises a locking member that is configured to be detachably or moveably attached to the attachment member. Hereby, it is possible to attach the attachment member to a pacifier so that the pacifier will not be dropped when the pacifier is removed from the body portion.

In one embodiment, the locking member is a slidably mounted ring-shaped locking member that surrounds the attachment member.

In one embodiment, the locking member is a slidably mounted locking member that surrounds only partly the attachment member. Hereby, the locking member can be attached to the attachment member in an easy and fast manner.

In one embodiment, the locking member is a slidably mounted locking member that comprises a C-shaped portion.

In one embodiment, the locking member is a slidably mounted locking member that comprises a first C-shaped end and a second C-shaped end.

In one embodiment, the locking member is a slidably mounted locking member that comprises a first C-shaped end and a second O-shaped end.

In one embodiment, the locking member is elastic and configured to press against the attachment member in such a manner that the locking member is fixed to the attachment member. Hereby, the locking member can be used to prevent the attachment member from being removed from the pacifier when the locking member presses against the pacifier.

### BRIEF DESCRIPTION OF THE DRAWINGS

The invention will become more fully understood from the detailed description given herein below. The accompanying drawings are given by way of illustration only, and thus, they are not limitative of the present invention. In the accompanying drawings:

FIG. 1 shows a schematic side view of a casing according to the invention;

FIG. 2 shows a casing according to the invention arranged in a purse;

FIG. 3 shows a casing according to the invention in a configuration, in which a pacifier has been inserted into the inner space of the body portion of the casing;

FIG. 4 shows a casing according to the invention and a plurality of measurements of the casing;

FIG. 5 shows a casing according to the invention suspended on a rod structure;

FIG. 6A shows a casing according to the invention and a pacifier arranged next to it;

FIG. 6B shows the casing shown in FIG. 6A in a configuration in which the pacifier is being inserted into the casing;

FIG. 6C shows the casing shown in FIG. 6A and FIG. 6B in a configuration in which the pacifier is arranged in the inner space of the body portion of the casing;

FIG. 7A shows an attachment member of a casing according to the invention, wherein a locking member shaped as an elastic ring surrounds and thereby is attached to the attachment member;

FIG. 7B shows the attachment member shown in FIG. 7A in a configuration in which the attachment member is fixed to a pacifier;

FIG. 7C shows a cross-sectional view of a locking member attached to an attachment member;

FIG. 7D shows a perspective of the locking member attached to the attachment member shown in FIG. 7C;

FIG. 8A shows an attachment member corresponding to the one shown in FIG. 7A and FIG. 7B arranged next to a pacifier;

FIG. 8B shows the attachment member shown in FIG. 8A in a configuration in which the attachment member is fixed to the pacifier;

FIG. 8C shows a cross-sectional view of a locking member attached to an attachment member;

FIG. 8D shows a cross-sectional view of a locking member attached to an attachment member; and

FIG. 8E shows a perspective of the locking member attached to the attachment member shown in FIG. 8C.

### DETAILED DESCRIPTION

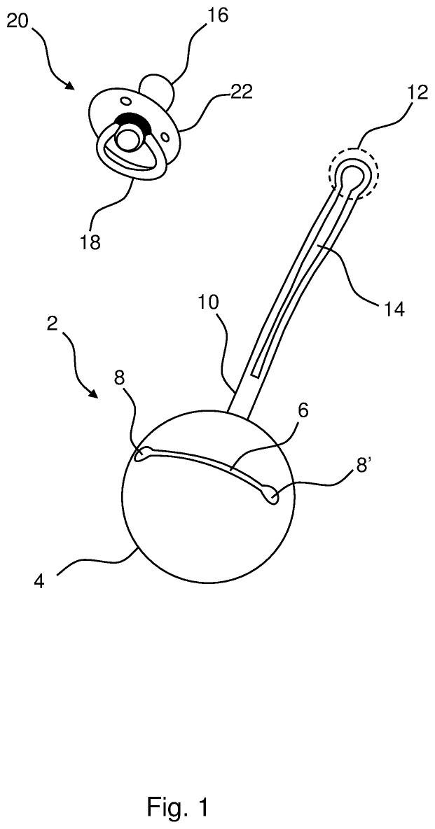

Referring now in detail to the drawings for the purpose of illustrating embodiments of the present invention, a casing 2 of the present invention is illustrated in FIG. 1.

FIG. 1 illustrates a schematic side view of a casing 2 according to the invention. A prior art pacifier 20 is arranged next to the casing 2. The pacifier comprises a nipple structure 16, a base 22 and a handle 18.

The casing 2 comprises a body portion 4 and an attachment member 10 attached thereto. The body portion 4 is hollow and spherical. A slot 6 for inserting a pacifier is provided in the body portion 4. A first round-off portion 8 is provided in the first end of the slot 6 and second round-off portion 8′ is provided in the second end of the slot 6.

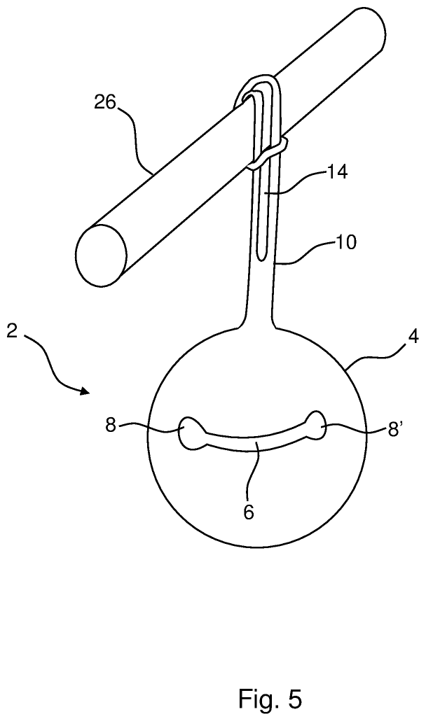

The round-off portions 8, 8′ prevent the slot 6 from cracking during use of the casing 2. The attachment member 10 is formed as an elongated structure provided with an open part 14. The open part 14 is large enough to receive the body portion 4 so that the attachment member 10 can be used to fix the casing to a structure (e.g. the rod structure 26 shown in FIG. 5).

The distal portion 12 of the attachment member 10 has a larger width than the remaining portion of the attachment member 10. Hereby, it is easier to hang the attachment member 10 on a structure such as a coat hook.

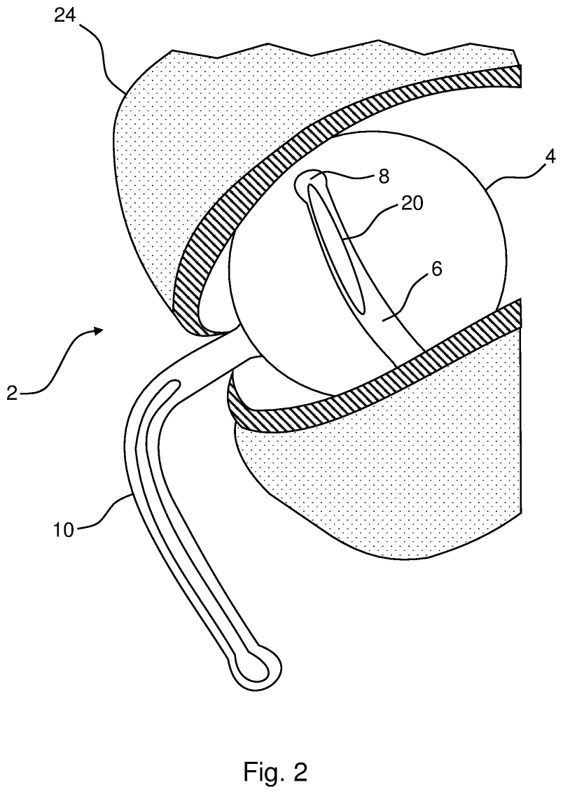

FIG. 2 illustrates a casing 2 according to the invention arranged in a purse 24. The casing 2 corresponds to the one shown in FIG. 1 and comprises an attachment member 10 that protrudes from the body portion 4 of the casing 2. A pacifier 20 has been inserted into the inner space of the body portion 4 through the slot 6 provided on the body portion 4. It can be seen that the slot 6 has a round-off portion 8.

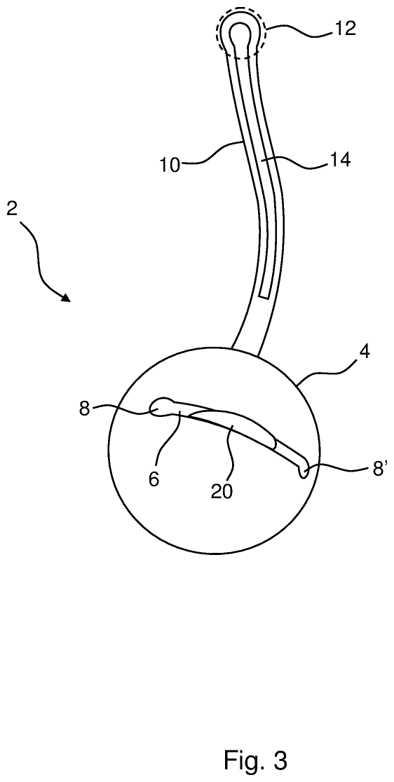

FIG. 3 illustrates a casing 2 according to the invention in a configuration in which a pacifier 20 has been inserted into the inner space of the body portion 4 of the casing 2. It can be seen that the inner space of the body portion 4 is large enough to completely contain the pacifier 20. The casing 2 corresponds to the one shown in FIG. 1.

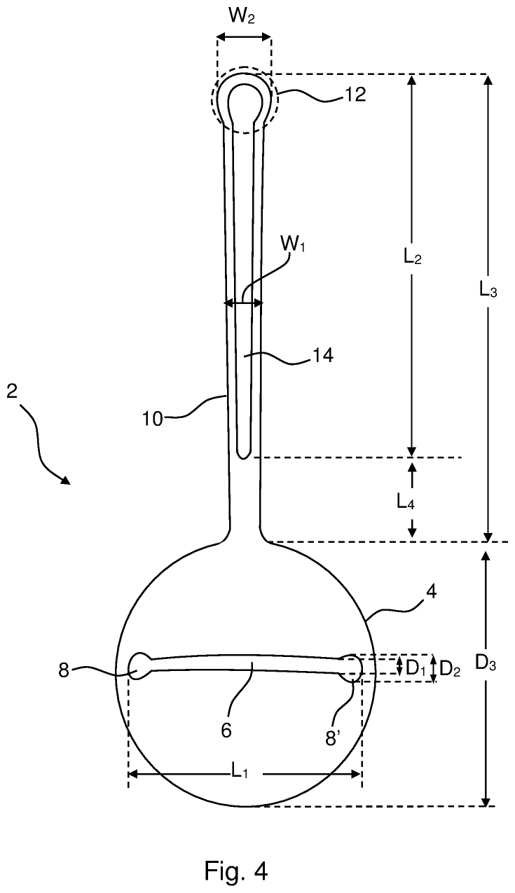

FIG. 4 illustrates a casing 2 according to the invention and a plurality of measurement markings. The casing 2 corresponds to the one shown in FIG. 1 and FIG. 3.

It can be seen that the length L₁ of the slit 6 is smaller than the diameter D₃ of the body portion 4. The diameter D₂ of the round-off portions 8, 8′ is larger than the diameter D₁ of the slot 6.

The length L₂ of the open part 14 of the attachment member 10 is larger than the diameter D₃ of the body portion 4. Moreover, the length L₃ of attachment member 10 is larger than the length L₂ of the open part 14 of the attachment member 10.

The length L₄ of the non-open part of the attachment member 10 is larger than width W₂ of the distal portion 12 of the attachment member 10. The width W₂ of the distal portion 12 of the attachment member 10 is larger than the width W₁ of central portion of the attachment member 10.

It may be an advantage that the casing 2 is made of an elastic material that is suitable for being washed in a washing machine at a temperature high enough to sterilize all of the surfaces of the casing 2.

FIG. 5 illustrates a casing 2 according to the invention suspended on a rod structure 26. The casing 2 corresponds to the casing shown and explained with reference to FIG. 1, FIG. 3 and FIG. 4.

The body portion 4 has been inserted through the open part 14 of the attachment member 10 to fix the attachment member 10 to the rod structure 26.

Accordingly, the casing 2 can be attached to a baby carriage (a pram) or a stroller in an easy manner.

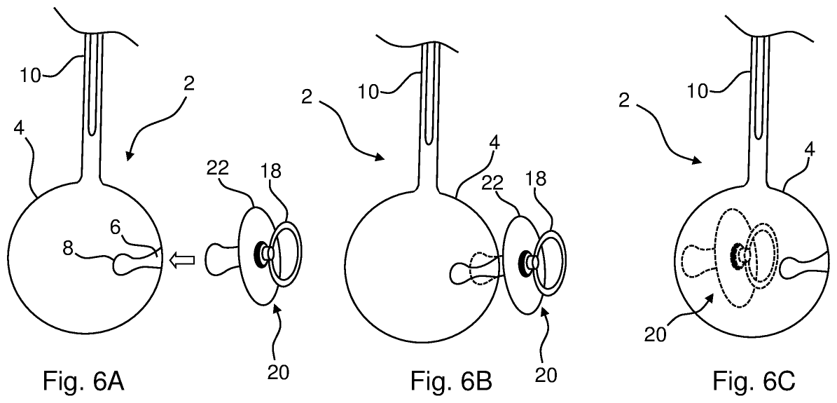

FIG. 6A illustrates a casing 2 according to the invention and a pacifier 20 arranged next to it. FIG. 6B illustrates the casing shown in FIG. 6A in a configuration in which the pacifier 20 is being inserted into the casing 2. FIG. 6C illustrates the casing 2 shown in FIG. 6A and FIG. 6B in a configuration in which the pacifier 20 is arranged in the inner space of the body portion 4 of the casing 2. The casing 2 corresponds to the casing shown and explained with reference to FIG. 1, FIG. 3 and FIG. 4.

Even though it is not shown, it is possible to let the handle 18 or the base 22 of the pacifier extend at least partly out through the slot 6 for easing the removal of the pacifier 20 from the casing 2.

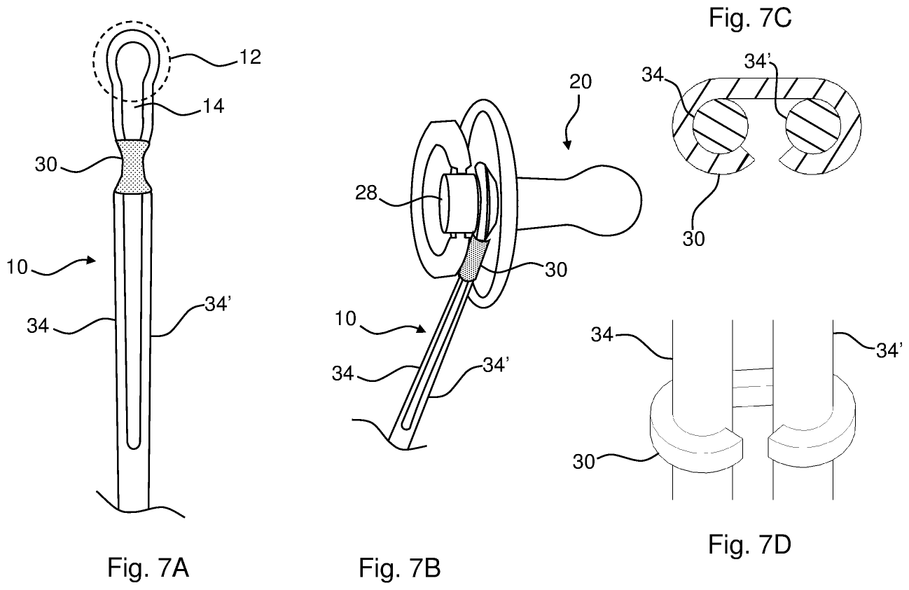

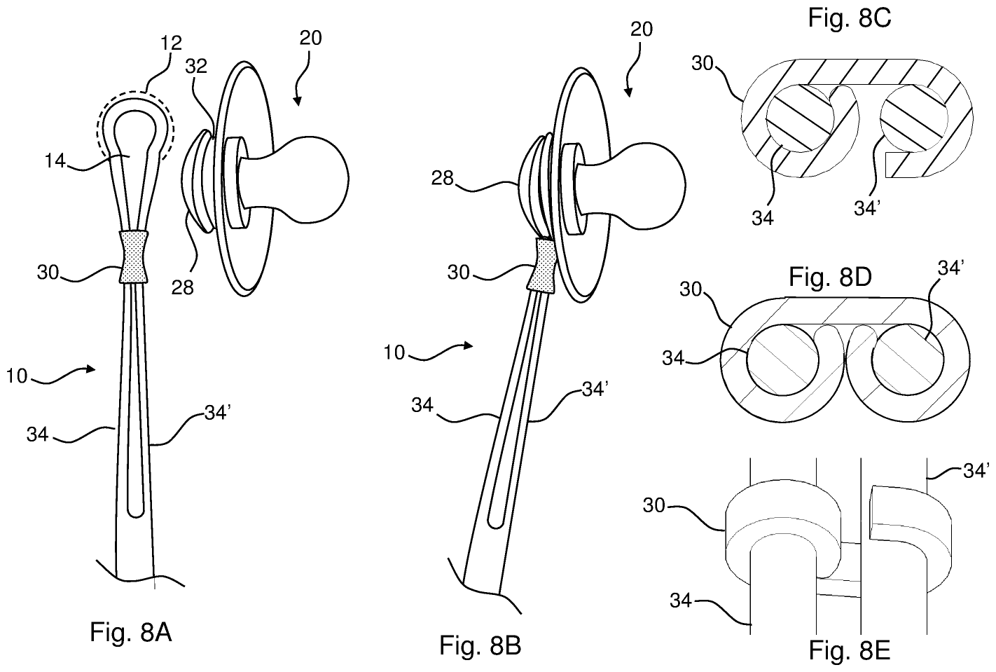

In one embodiment (as shown in FIG. 7A, FIG. 7B, FIG. 8A and FIG. 8B), the casing 2 is provided with a locking member for locking the distal end of the attachment member 10 to a protruding structure of a pacifier 20.

FIG. 7A illustrates an attachment member 10 of a casing according to the invention, wherein a locking member 30 shaped as an elastic ring surrounds and hereby is attached to the attachment member 10. FIG. 7B illustrates the attachment member 10 shown in FIG. 7A in a configuration in which the attachment member 10 is fixed to a pacifier 20. To fix the attachment member 10 to the pacifier 20, the open part 14 of the attachment member 10 is arranged around the protruding member 28 of the pacifier 20. Hereafter the locking member 30 is moved as much as possible towards the free end of the attachment member 10. Hereby, the locking member 30 prevents the attachment member 10 from being released from the pacifier 20. When the pacifier 20 must be detached from the attachment member 10, the locking member 30 needs to be moved towards the proximal end of the attachment member 10 in order to allow the attachment member to be removed from the pacifier 20. The attachment member 10 comprises a first leg 34 and a second leg 34′ that are interconnected to form the open part 14.

FIG. 7C illustrates a cross-sectional view of a locking member 30 attached to an attachment member 10. FIG. 7D illustrates a perspective view of the locking member attached to the attachment member shown in FIG. 7C. The locking member 30 attached to the attachment member 10 is attached to both legs 34, 34′ of the attachment member 10. The locking member 30 is symmetric. The locking member is shaped and configured to be attached to the attachment member 10 without inserting the distal portion of the attachment member through the locking member 30. Accordingly, attachment and detachment of the locking member 30 to the attachment member 10 is easy. The locking member 30 clamps against the legs 34, 34′ of the attachment member 10 and hereby a firm fixation of the locking member 30 to the attachment member 10 can be achieved.

FIG. 8A illustrates an attachment member 10 corresponding to the one shown in FIG. 8A before the attachment member 10 is attached to a pacifier 20. FIG. 8B illustrates the attachment member 10 shown in FIG. 8A in a configuration in which a protruding attachment member 10 has been fixed to the pacifier 20.

The attachment member 10 is configured to be arranged in such a manner that the open part 14 of the attachment member can receive a protruding member 28 of a pacifier 20. The pacifier 20 has a recessed portion 32. The attachment member 10 is configured to be arranged in the recessed portion 32 to be firmly fixed to the pacifier 20.

FIG. 8C illustrates a cross-sectional view of a locking member 30 attached to an attachment member. The locking member 30 comprises a first O-shaped end that is fixed to the first leg 34 of the attachment member. The locking member 30 also comprises a second C-shaped end that partly surrounds the second leg 34′ of the attachment member.

FIG. 8D illustrates a cross-sectional view of a locking member 30 attached to both legs 34, 34′ of an attachment member. The locking member 30 comprises a first O-shaped end that is fixed to the first leg 34 of the attachment member. The locking member 30 also comprises a second O-shaped end that is fixed to the second leg 34′ of the attachment member.

FIG. 8E illustrates a perspective view of the locking member attached to an attachment member shown in FIG. 8C. The locking member 30 attached to an attachment member 10 is attached to one of the two legs 34, 34′ of the attachment member 10. The locking member 30 is not symmetric. The locking member 10 is shaped and configured to be attached to the attachment member 10 without inserting the distal portion of the attachment member through the locking member 30. Accordingly, attachment and detachment of the locking member 30 to the attachment member 10 is easy. The locking member 30 clamps against one of the legs 34, 34′ of the attachment member 10 and hereby a firm fixation of the locking member 30 to the attachment member 10 can be achieved.

### LIST OF REFERENCE NUMERALS

2 Casing
4 Body portion
6 Slot
8 Round-off portion
10 Attachment member
12 Distal portion
14 Open part
16 Nipple structure
18 Handle
20 Pacifier
22 Base
24 Purse
26 Rod structure
28 Protruding member
30 Locking member
32 Recessed portion
34, 34′ Leg
D₁, D₂, D₃ Diameter
W₁, W₂ Width
L₁, L₂, L₃, L₄ Length

1. A casing for pacifiers, wherein the casing comprises:
a body portion having an inner space large enough to receive and contain at least one pacifier,
wherein the body portion is provided with a slot large enough to let a pacifier enter the inner space through the slot,
wherein the body portion is configured to be arranged in a resting configuration, in which the opening in the slot is so small that the pacifier cannot pass through the slot, and an open configuration, in which the opening in the slot is large enough to let the pacifier pass through the slot,
wherein the body portion is configured to reshape to its resting configuration when no external contact forces are applied to the body portion.

2. A casing according to claim 1, wherein the casing is provided with an attachment member fixed to the body portion, wherein the attachment member comprises an elongated open part large enough to let the body portion pass through the open part.

3. A casing according to claim 1, wherein the body portion is spherical in the resting configuration.

4. A casing according to claim 1, wherein the body portion is made of a resilient and compressible material such as rubber or silicone.

5. A casing according to claim 1, wherein the slot extends along at least 60 degrees of the surface of the body portion.

6. A casing according to claim 1, wherein a round-off portion is provided at each end of the slot.

7. A casing according to claim 6, wherein the round-off portions are each shaped as a sector of a circle.

8. A casing according to claim 1, wherein the thickness of the slot is less than 10% of the thickness of the body portion.

9. A casing according to claim 2, wherein the length of the open part is more than half the length of the attachment member.

10. A casing according to claim 2, wherein the attachment member comprises a distal portion having a larger width than the width of the central portion of the attachment member.

11. A casing according to claim 1, wherein the thickness of the body portion is larger than the length of the slot.

12. A casing according to claim 1, wherein the thickness of the wall of the body portion is in the range 0.5-5 mm.

13. A casing according to claim 2, wherein the inner space of the body portion is configured to contain at least three pacifiers of small size adapted to fit children of 0-6 months.

14. A casing according to claim 1, wherein the inner space of the body portion has a volume in the range 50-300 cm³.

15. A casing according to claim 1, wherein a locking member is detachably or moveably attached to the attachment member.

16. A casing according to claim 15, wherein the locking member is a slidably mounted ring-shaped locking member that surrounds the attachment member.

17. A casing according to claim 15, wherein the locking member is a slidably mounted locking member that surrounds only part of the attachment member.

18. A casing according to claim 15, wherein the locking member is a slidably mounted locking member that comprises a C-shaped portion.

19. A casing according to claim 15, wherein the locking member is a slidably mounted locking member that comprises a first C-shaped end and a second C-shaped end.

20. A casing according to claim 15, wherein the locking member is a slidably mounted locking member that comprises a first C-shaped end and a second O-shaped end.

21. A casing according to claim 15, wherein the locking member is elastic and configured to press against the attachment member in such a manner that the locking member is fixed to the attachment member.
